(19) United States
(12) Patent Application Publication
(10) Pub. No.: US 2024/0303077 A1
(43) Pub. Date: Sep. 12, 2024

(54) SEMICONDUCTOR DEVICE, CORRELATION VALUE OPERATION METHOD, AND RECORDING MEDIUM

(71) Applicant: LAPIS Technology Co., Ltd., Yokohama (JP)

(72) Inventor: Atsushi YAMAZAKI, Yokohama (JP)

(73) Assignee: LAPIS Technology Co., Ltd., Yokohama (JP)

(21) Appl. No.: 18/597,808

(22) Filed: Mar. 6, 2024

(30) Foreign Application Priority Data
Mar. 7, 2023 (JP) 2023-034903

(51) Int. Cl. G06F 9/30

(52) U.S. Cl. CPC G06F 9/30021

(57) ABSTRACT

A semiconductor device, a correlation value operation method, and a recording medium are provided. The semiconductor device includes a first processing unit, alternately arranging two input bit strings on a bit-by-bit basis and outputting as one bit string; a second processing unit, outputting 2-bit data from each 2-bit data set from a head of each of the two input bit strings according to any predetermined logic; and a third processing unit, outputting a number of bit values of 1 in one input bit string as a value.

### CROSS-REFERENCE TO RELATED APPLICATION

This application claims priority under 35 USC 119 from Japanese Patent application No. 2023-034903 filed on Mar. 7, 2023, the disclosure of which is incorporated by reference herein.

### BACKGROUND

### Technical Field

The disclosure relates to a semiconductor device, a correlation value operation method, and a recording medium.

### Description of Related Art

In Citation document 1 (Japanese Patent Application Laid-Open (JP-A) No. 2017-173332), a processor used in a global navigation satellite system, such as the global positioning system, for example, is described.

For example, in a processor used in a global navigation satellite system, two bit strings of a comparison value P and a comparison value N in a complementary relationship are generated based on the input from the analog radio signal, and the two bit strings of the comparison value P and the comparison value N are compared with two bit strings of an expected value P and an expected value N, which are also in a complementary relationship, and the correlation value of the comparison value to the expected values is operated.

When the operation of the correlation value is processed by a dedicated processor, although it can be processed faster than when processed by a general central processing unit (CPU), as it is equipped with hardware processing functions capable of efficiently operating correlation values, since the bit length of the expected value is fixed, it is difficult to change functions such as changing the bit length of the expected value.

Conversely, when the operation of the correlation value is processed by a general CPU, it is easy to change functions, but since the CPU is not equipped with hardware processing functions capable of efficiently operating correlation values, more instructions are required and a longer processing time is needed than when the correlation value is processed by a dedicated processor.

In view of the above situation, the disclosure provides a semiconductor device, a correlation value operation method, and a recording medium recording a program that is capable of executing the operation of the correlation value in a short processing time even when the bit length of the expected value is made variable.

### SUMMARY

The semiconductor device in the disclosure includes: a first processing unit, alternately arranging two input bit strings on a bit-by-bit basis and outputting as one bit string; a second processing unit, outputting 2-bit data from each 2-bit data set from a head of each of the two input bit strings according to any predetermined logic; and a third processing unit, outputting a number of bit values of 1 in one input bit string as a value.

The correlation value operation method of the disclosure operates a correlation value of a comparison value to an expected value using the semiconductor device according to aspect 1. The expected value has two bit strings, an expected value P and an expected value N, which have a complementary relationship, while the comparison value has two bit strings, a comparison value P and a comparison value N, which have a complementary relationship. n is an arbitrary number, and the correlation value operation method includes: a step in which the second processing unit is set so that bit values of 01 are output in a first condition where two 2-bit data of bit values of 01 and bit values of 01 or two 2-bit data of bit values of 10 and bit values of 10 are input as the data set, bit values of 10 are output in a second condition where two 2-bit data of bit values of 01 and bit values of 10 or two 2-bit data of bit values of 10 and bit values of 01 are input as the data set, and bit values of 00 are output in a third condition where two 2-bit data other than the first condition and the second condition are input as the data set; a step in which an expected value PN with a length of 2n bits is obtained from the expected value P with a length of n bits and the expected value N with a length of n bits using the first processing unit; a step in which a comparison value PN with a length of 2n bits is obtained from the comparison value P with a length of n bits and the comparison value N with a length of n bits using the first processing unit; a step in which an output value with a length of 2n bits is obtained from the comparison value PN with a length of 2n bits and the expected value PN with a length of 2n bits using the second processing unit; a step in which a number of bit values of 1 in odd-numbered bits from a head of a bit string of the output value is obtained as a first value using the third processing unit; a step in which a number of bit values of 1 in even-numbered bits from the head of the bit string of the output value is obtained as a second value using the third processing unit; and a step in which the second value is subtracted from the first value to obtain the correlation value.

The program recorded in the non-transient computer-readable recording medium of the disclosure operates a correlation value of a comparison value to an expected value using the semiconductor device according to aspect 1. The expected value has two bit strings, an expected value P and an expected value N, which have a complementary relationship, while the comparison value has two bit strings, a comparison value P and a comparison value N, which have a complementary relationship. n is an arbitrary number, and the program causes a computer to execute: a step in which the second processing unit is set so that bit values of 01 are output in a first condition where two 2-bit data of bit values of 01 and bit values of 01 or two 2-bit data of bit values of 10 and bit values of 10 are input as the data set, bit values of 10 are output in a second condition where two 2-bit data of bit values of 01 and bit values of 10 or two 2-bit data of bit values of 10 and bit values of 01 are input as the data set, and bit values of 00 are output in a third condition where two 2-bit data other than the first condition and the second condition are input as the data set; a step in which an expected value PN with a length of 2n bits is obtained from the expected value P with a length of n bits and the expected value N with a length of n bits using the first processing unit; a step in which a comparison value PN with a length of 2n bits is obtained from the comparison value P with a length of n bits and the comparison value N with a length of n bits using the first processing unit; a step in which an output value with a length of 2n bits is obtained from the comparison value PN with a length of 2n bits and the expected value PN with a length of 2n bits using the second processing unit; a step in which a number of bit values of 1 in odd-numbered bits from a head of a bit string of the output value is obtained as a first value using the third processing unit; a step in which a number of bit values of 1 in even-numbered bits from the head of the bit string of the output value is obtained as a second value using the third processing unit; and a step in which the second value is subtracted from the first value to obtain the correlation value.

It should be noted that, in this specification and drawings, a bit string is expressed with the right side being the head bit.

### BRIEF DESCRIPTION OF THE DRAWINGS

FIG. 1 is a block diagram showing the hardware configuration of the computer according to one embodiment of the disclosure.

FIG. 2 is a diagram illustrating the functions of the first processing unit.

FIG. 3 is a diagram illustrating the functions of a second processing unit.

FIG. 4 is a diagram illustrating the functions of a second processing unit.

FIG. 5 is a diagram illustrating the functions of the third processing unit.

FIG. 6 is a diagram illustrating the method of operating the correlation value of the comparison value to the expected value using the CPU of this embodiment.

FIG. 7 is a diagram illustrating the method of operating the correlation value of the comparison value to the expected value using the CPU of this embodiment.

FIG. 8 is a diagram illustrating the method of operating the correlation value of the comparison value to the expected value using the CPU of this embodiment.

### DESCRIPTION OF THE EMBODIMENTS

According to the semiconductor device, the correlation value operation method, and the program of the disclosure, the operation of the correlation value is efficiently processed.

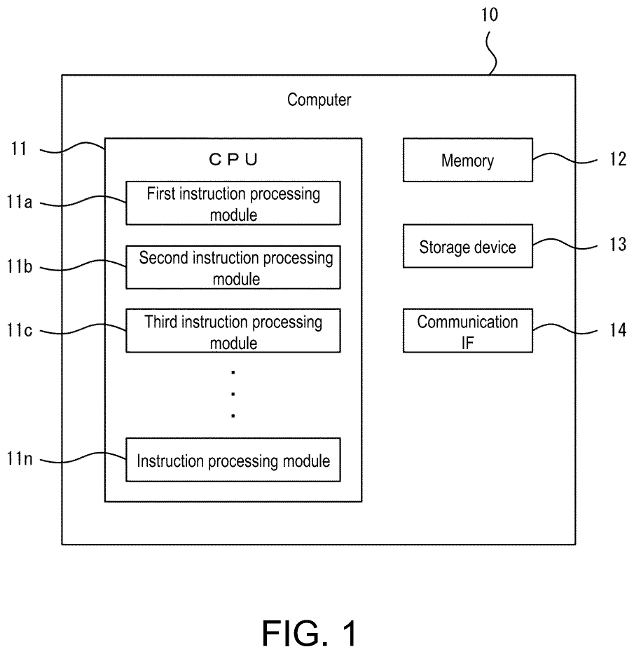

Hereinafter, the embodiments of the disclosure are described with reference to the drawings. FIG. 1 is a block diagram showing the hardware configuration of the computer 10 according to one embodiment of the disclosure.

As shown in FIG. 1, the computer 10 of this embodiment includes a CPU 11, a memory 12, a storage device 13 such as a hard disk drive, and a communication interface (abbreviated as IF) 14 that transmits and receives data to and from external devices, etc. via a network. These components are connected to each other via a control bus (not shown).

The CPU 11 is an example of a semiconductor device in the technology of the disclosure and is a processor that controls the operation of the computer 10 by executing a predetermined process based on the program stored in the memory 12 or the storage device 13. In addition, in this embodiment, the CPU 11 is described as reading and executing the program stored in the memory 12 or the storage device 13, but it is not limited thereto.

For example, the program may be provided in a form recorded on a computer-readable recording medium. For example, the program may be provided in the form of being recorded on an optical disc such as a CD (compact disc)-ROM (Read Only Memory) or DVD (digital versatile disc)-ROM, or in the form of being recorded in a semiconductor memory such as a USB (universal serial bus) memory or a memory card. Alternatively, the program may be obtained from an external device via a communication line connected to the communication IF 14.

The CPU 11 includes multiple instruction processing modules, including a first instruction processing module 11a, a second instruction processing module 11b, and a third instruction processing module 11c, which perform specific processing by hardware.

The functions of the first instruction processing module 11a, the second instruction processing module 11b, and the third instruction processing module 11c are described in detail below. It should be noted that, in the following description and drawings, a bit string is expressed with the right side being the head bit.

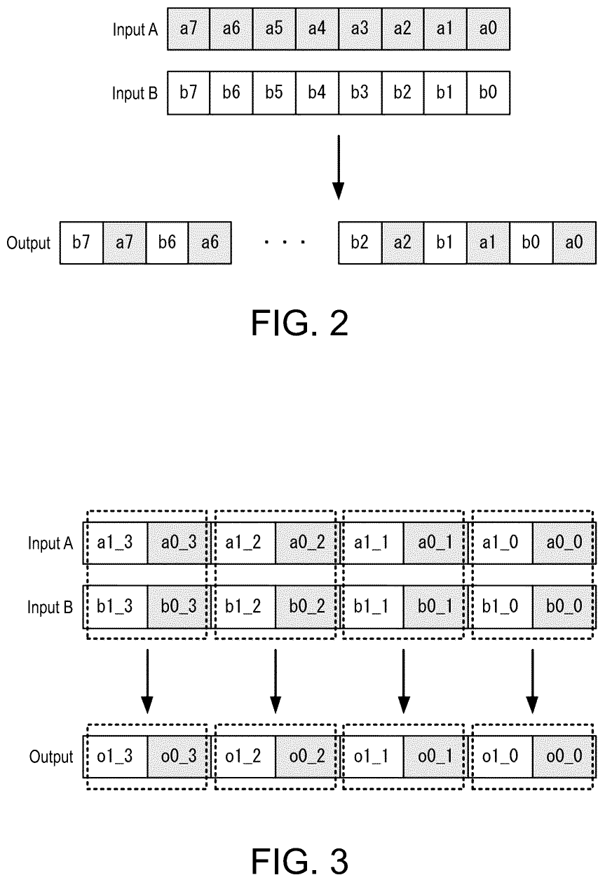

The first instruction processing module 11a is an example of the first processing unit in the technology of the disclosure, and as shown in FIG. 2, two input bit strings are alternately arranged on a bit-by-bit basis and output as one bit string. It should be noted that there is no particular restriction on the maximum bit length of the bit string input to the first instruction processing module 11a, and any maximum bit length may be used.

In the example shown in FIG. 2, input A is the 8-bit bit string from a7 to a0, input B is the 8-bit bit string from b7 to b0, the two bit strings are alternately arranged on a bit-by-bit basis and output as one bit string of b7, a7, b6, a6, . . . , b0, a0.

The second instruction processing module 11b is an example of the second processing unit in the technology of the disclosure, and as shown in FIG. 3, 2-bit data is output simultaneously and in parallel from each 2-bit data set from a head of each of the two input bit strings according to any predetermined logic. It should be noted that there is no particular restriction on the maximum bit length of the bit string input to the second instruction processing module 11b, and any maximum bit length may be used.

In the example shown in FIG. 3, input A is the 8-bit bit string from a1_3 to a0_0, input B is the 8-bit bit string from b1_3 to b0_0, and in the order from the head, o1_0 and o0_0 are output from the data set of a1_0, a0_0, b1_0, and b0_0, o1_1 and o0_1 are output from the data set of a1_1, a0_1, b1_1, and b0_1, o1_2 and o0_2 are output from the data set of a1_2, a0_2, b1_2, and b0_2, and o1_3 and o0_3 are output from the data set of a1_3, a0_3, b1_3, and b0_3.

It should be noted that there is no particular restriction on the logic for outputting 2-bit data from a 2-bit data set, and any logic may be used.

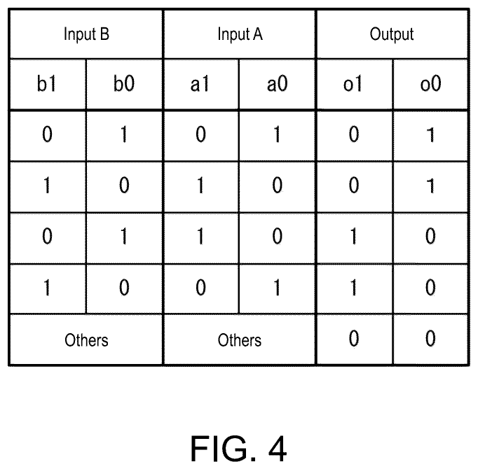

For example, as shown in FIG. 4, it may be set such that bit values of 01 are output in a first condition where two 2-bit data of bit values of 01 and bit values of 01 or two 2-bit data of bit values of 10 and bit values of 10 are input as the data set, bit values of 10 are output in a second condition where two 2-bit data of bit values of 01 and bit values of 10 or two 2-bit data of bit values of 10 and bit values of 01 are input as the data set, and bit values of 00 are output in a third condition where two 2-bit data other than the first condition and the second condition are input as the data set.

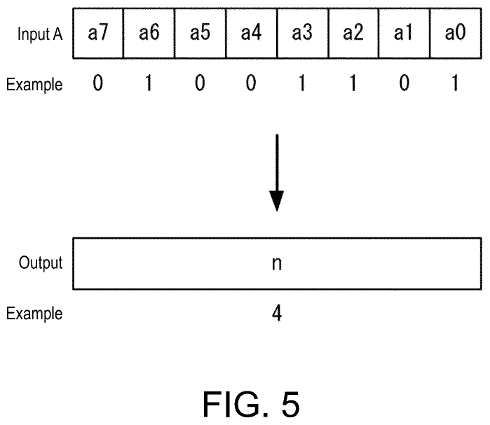

The third instruction processing module 11c is an example of the third processing unit in the technology of the disclosure, and as shown in FIG. 5, a number of bit values of 1 in one input bit string is output as a value.

In the example shown in FIG. 5, input A is the 8-bit bit string from a7 to a0 (01001101 in the example in FIG. 5), and the number n (n=4 in the example in FIG. 5) of bit values of 1 in the bit string of input A is output.

Next, the method of operating the correlation value of the comparison value to the expected value using the CPU 11 of this embodiment is described.

In this embodiment, when the bit length of the expected value and the comparison value is n bits, the correlation value is represented as correlation value=n when all bits of the expected value and the comparison value match, and correlation value=−n when all bits of the expected value and the comparison value do not match.

The expected value has two bit strings, an expected value P and an expected value N, which have a complementary relationship. In this description, the expected value P and the expected value N are assumed to be the following 8-bit bit string, as an example. It should be noted that the bit lengths of the expected value P and the expected value N are not limited to 8 bits, and may be any bit length.

Expected value P: 01110101

Expected value N: 10001010

The comparison value includes, for example, two bit strings of the comparison value P and the comparison value N in a complementary relationship, which is data generated based on the input from the analog radio signal. It should be noted that although the comparison value P and the comparison value N are normally in the complementary relationship, there may be cases where they are not in a complementary relationship due to the influence of noise or the like. In this description, the comparison value P and the comparison value N are assumed to be the following 8-bit bit string, as an example. It should be noted that the bit lengths of the comparison value P and the comparison value N are not limited to 8 bits, and may be any bit length. Here, the comparison value P, the comparison value N and the expected value P, the expected value N have the same data content.

Comparison value P: 01110101

Comparison value N: 10001010

As the first step, as shown in FIG. 4, the CPU 11 sets the second instruction processing module 11b so that bit values of 01 are output in a first condition where two 2-bit data of bit values of 01 and bit values of 01 or two 2-bit data of bit values of 10 and bit values of 10 are input as the data set, bit values of 10 are output in a second condition where two 2-bit data of bit values of 01 and bit values of 10 or two 2-bit data of bit values of 10 and bit values of 01 are input as the data set, and bit values of 00 are output in a third condition where two 2-bit data other than the first condition and the second condition are input as the data set.

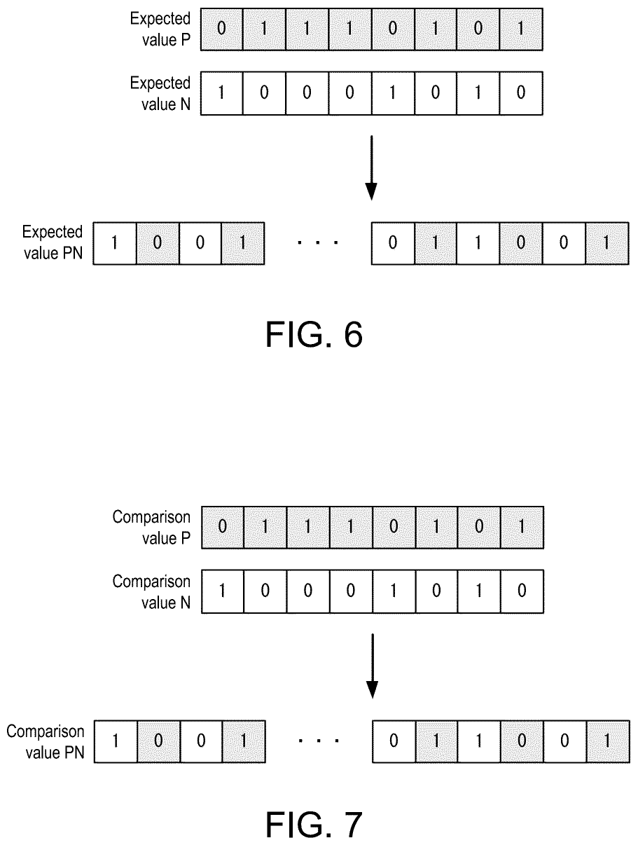

As the second step, as shown in FIG. 6, the CPU 11 uses the first instruction processing module 11a to alternately arranging two input bit strings of the expected value P with a length of 8 bits and the expected value N with a length of 8 bits on a bit-by-bit basis and obtain one expected value PN with a length of 16 bits as shown below.

Expected value PN: 1001010110011001

As the third step, as shown in FIG. 7, the CPU 11 uses the first instruction processing module 11a to alternately arranging two input bit strings of the comparison value P with a length of 8 bits and the comparison value N with a length of 8 bits on a bit-by-bit basis and obtain one comparison value PN with a length of 16 bits as shown below.

Comparison value PN: 1001010110011001

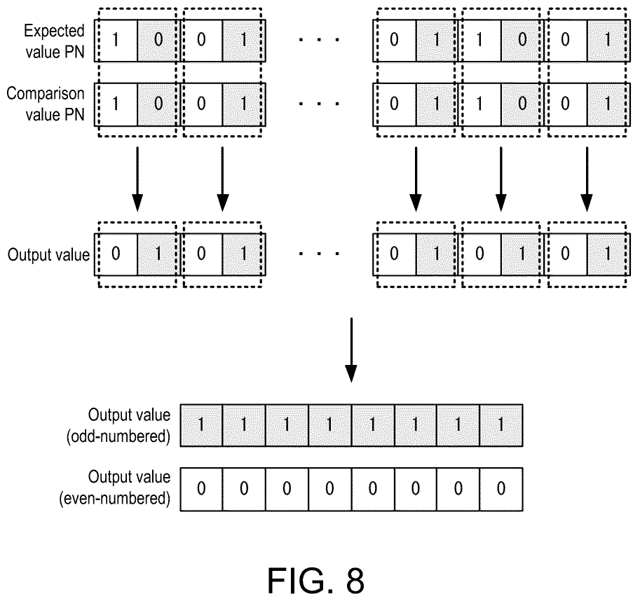

As the fourth step, as shown in FIG. 8, the CPU 11 uses the second instruction processing module 11b to obtain an output value with a length of 16 bits from the comparison value PN with a length of 16 bits and the expected value PN with a length of 16 bits.

Specifically, 2-bit data sets from the head of each of the comparison value PN and the expected value PN are set, and the 2-bit data are output simultaneously and in parallel according to the logic set in the first step.

In the example shown in FIG. 8, in the order from the head, 01 is output from the data set of 01 and 01, 01 is output from the data set of 10 and 10, 01 is output from the data set of 01 and 01, 01 is output from the data set of 10 and 10, 01 is output from the data set of 01 and 01, 01 is output from the data set of 01 and 01, 01 is output from the data set of 01 and 01, 01 is output from the data set of 10 and 10, as a result, the following output value is obtained.

Output value: 0101010101010101

As the fifth step, as shown in FIG. 8, the CPU 11 uses the third instruction processing module 11c to obtain a number of bit values of 1 in odd-numbered bits from a head of a bit string of the output value as a first value.

It should be noted that there is no particular restriction on the method for obtaining the number of bit values of 1 in odd-numbered bits from the head of the bit string of the output value, and any method may be used. For example, a logical AND operation may be performed on all bits of the output value with data that has the odd-numbered bit value of 1 and the even-numbered bit value of 0 to obtain the number of bit values of 1 in the resulting bit string. In this case, as an example, in the case that the bit length of the output value is 16 bits, it is sufficient to perform a logical AND operation on data of the output value and data of 0x5555. In addition to the above, only odd-numbered data may be extracted from the bit string of the output value, and the number of bit values of 1 in the extracted data may be obtained.

In the example shown in FIG. 8, the odd-numbered bits from the head of the bit string of the output value are all 1, so “8” is obtained as the first value.

Output value (odd-numbered): 11111111

As the sixth step, as shown in FIG. 8, the CPU 11 uses the third instruction processing module 11c to obtain a number of bit values of 1 in even-numbered bits from a head of a bit string of the output value as a second value.

It should be noted that there is no particular restriction on the method for obtaining the number of bit values of 1 in even-numbered bits from the head of the bit string of the output value, and any method may be used. For example, a logical AND operation may be performed on all bits of the output value with data that has the odd-numbered bit value of 0 and the even-numbered bit value of 1 to obtain the number of bit values of 1 in the resulting bit string. In this case, as an example, in the case that the bit length of the output value is 16 bits, it is sufficient to perform a logical AND operation on data of the output value and data of 0xaaaa. In addition to the above, only even-numbered data may be extracted from the bit string of the output value, and the number of bit values of 1 in the extracted data may be obtained.

In the example shown in FIG. 8, the even-numbered bits from the head of the bit string of the output value are all 0, so “0” is obtained as the second value.

Output value (even-numbered): 00000000

As the seventh step, the CPU 11 subtracts the second value from the first value to obtain the correlation value. In the example shown in FIG. 8, “8” is obtained as the first value and “0” is obtained as the second value, so the correlation value is 8-0-8.

Since a general CPU without the first instruction processing module 11a, the second instruction processing module 11b, and third instruction processing module 11c requires more than 10 instructions to obtain a 1-bit correlation value, for example, more than 80 instructions are required to obtain an 8-bit correlation value.

Conversely, by using the CPU 11 in this embodiment to operate the correlation value of the comparison value to the expected value, the correlation value may be obtained by executing only seven instructions, regardless of the bit length of the expected value and the comparison value, as described above, and the operation of the correlation value may be processed efficiently.

Although the computer 10 according to one embodiment of the disclosure has been described above, the disclosure is not limited to the above embodiment.

For example, the order of steps when operating the correlation value of the comparison value to the expected value using the CPU 11 is not limited to the order from the first step to the seventh step above, the order may be changed as appropriate as long as correlation value may be calculated.

In addition to the above, unnecessary sections may be deleted, and new elements may be added or substituted for the descriptions and drawings shown above to the extent that it does not depart from the main purpose of the technology of the present disclosure.

What is claimed is:

1. A semiconductor device, comprising:
a first processing unit, alternately arranging two input bit strings on a bit-by-bit basis and outputting as one bit string;
a second processing unit, outputting 2-bit data from each 2-bit data set from a head of each of the two input bit strings according to any predetermined logic; and
a third processing unit, outputting a number of bit values of 1 in one input bit string as a value.

2. The semiconductor device according to claim 1, wherein when calculating a correlation value of a comparison value to an expected value,
the expected value has two bit strings, an expected value P and an expected value N, which have a complementary relationship, while
the comparison value has two bit strings, a comparison value P and a comparison value N, which have a complementary relationship,
where n is an arbitrary number, and the semiconductor device executes:
a process in which the second processing unit is set so that bit values of 01 are output in a first condition where two 2-bit data of bit values of 01 and bit values of 01 or two 2-bit data of bit values of 10 and bit values of 10 are input as the data set, bit values of 10 are output in a second condition where two 2-bit data of bit values of 01 and bit values of 10 or two 2-bit data of bit values of 10 and bit values of 01 are input as the data set, and bit values of 00 are output in a third condition where two 2-bit data other than the first condition and the second condition are input as the data set;
a process in which an expected value PN with a length of 2n bits is obtained from the expected value P with a length of n bits and the expected value N with a length of n bits using the first processing unit;
a process in which a comparison value PN with a length of 2n bits is obtained from the comparison value P with a length of n bits and the comparison value N with a length of n bits using the first processing unit;
a process in which an output value with a length of 2n bits is obtained from the comparison value PN with a length of 2n bits and the expected value PN with a length of 2n bits using the second processing unit;
a process in which a number of bit values of 1 in odd-numbered bits from a head of a bit string of the output value is obtained as a first value using the third processing unit;
a process in which a number of bit values of 1 in even-numbered bits from the head of the bit string of the output value is obtained as a second value using the third processing unit; and
a process in which the second value is subtracted from the first value to obtain the correlation value.

3. A correlation value operation method for operating a correlation value of a comparison value to an expected value using the semiconductor device according to claim 1, wherein
the expected value has two bit strings, an expected value P and an expected value N, which have a complementary relationship, while
the comparison value has two bit strings, a comparison value P and a comparison value N, which have a complementary relationship,
where n is an arbitrary number, and the correlation value operation method comprises:
a step in which the second processing unit is set so that bit values of 01 are output in a first condition where two 2-bit data of bit values of 01 and bit values of 01 or two 2-bit data of bit values of 10 and bit values of 10 are input as the data set, bit values of 10 are output in a second condition where two 2-bit data of bit values of 01 and bit values of 10 or two 2-bit data of bit values of 10 and bit values of 01 are input as the data set, and bit values of 00 are output in a third condition where two 2-bit data other than the first condition and the second condition are input as the data set;
a step in which an expected value PN with a length of 2n bits is obtained from the expected value P with a length of n bits and the expected value N with a length of n bits using the first processing unit;
a step in which a comparison value PN with a length of 2n bits is obtained from the comparison value P with a length of n bits and the comparison value N with a length of n bits using the first processing unit;
a step in which an output value with a length of 2n bits is obtained from the comparison value PN with a length of 2n bits and the expected value PN with a length of 2n bits using the second processing unit;
a step in which a number of bit values of 1 in odd-numbered bits from a head of a bit string of the output value is obtained as a first value using the third processing unit;
a step in which a number of bit values of 1 in even-numbered bits from the head of the bit string of the output value is obtained as a second value using the third processing unit; and
a step in which the second value is subtracted from the first value to obtain the correlation value.

4. A non-transient computer-readable recording medium, recording a program for operating a correlation value of a comparison value to an expected value using the semiconductor device according to claim 1, wherein
the expected value has two bit strings, an expected value P and an expected value N, which have a complementary relationship, while
the comparison value has two bit strings, a comparison value P and a comparison value N, which have a complementary relationship,
where n is an arbitrary number, and the program causes a computer to execute:
a step in which the second processing unit is set so that bit values of 01 are output in a first condition where two 2-bit data of bit values of 01 and bit values of 01 or two 2-bit data of bit values of 10 and bit values of 10 are input as the data set, bit values of 10 are output in a second condition where two 2-bit data of bit values of 01 and bit values of 10 or two 2-bit data of bit values of 10 and bit values of 01 are input as the data set, and bit values of 00 are output in a third condition where two 2-bit data other than the first condition and the second condition are input as the data set;
a step in which an expected value PN with a length of 2n bits is obtained from the expected value P with a length of n bits and the expected value N with a length of n bits using the first processing unit;
a step in which a comparison value PN with a length of 2n bits is obtained from the comparison value P with a length of n bits and the comparison value N with a length of n bits using the first processing unit;
a step in which an output value with a length of 2n bits is obtained from the comparison value PN with a length of 2n bits and the expected value PN with a length of 2n bits using the second processing unit;
a step in which a number of bit values of 1 in odd-numbered bits from a head of a bit string of the output value is obtained as a first value using the third processing unit;
a step in which a number of bit values of 1 in even-numbered bits from the head of the bit string of the output value is obtained as a second value using the third processing unit; and
a step in which the second value is subtracted from the first value to obtain the correlation value.
